(19) United States
(12) Patent Application Publication
(10) Pub. No.: US 2025/0235813 A1
(43) Pub. Date: Jul. 24, 2025

(54) SYSTEMS AND PROCESSES FOR MAINTAINING CONTINUOUS CARBON DIOXIDE CAPTURE

(71) Applicant: SHELL USA, INC., Houston, TX (US)

(72) Inventors: Mark KLOKKENBURG, Amsterdam (NL); Sayee Prasaad BALAJI, Amsterdam (NL); Xiao FU, Amsterdam (NL)

(21) Appl. No.: 18/697,833

(22) PCT Filed: Oct. 18, 2022
(86) PCT No.: PCT/EP2022/078952

§ 371 Date: Apr. 2, 2024

(30) Foreign Application Priority Data
Oct. 21, 2021 (EP) 21204017.4

(51) Int. Cl. B01D 53/04; B01D 53/14

(52) U.S. Cl. CPC B01D 53/0462; B01D 53/1425; B01D 53/1475; B01D 2257/504; B01D 2258/06; B01D 2259/655

(57) ABSTRACT

This invention provides systems and processes for operating systems that can operate continuously to remove carbon dioxide from an atmosphere under power from a wide range of intermittent renewable energy sources.

### FIELD OF THE INVENTION

This invention relates to capture of carbon dioxide from a carbon dioxide containing gas stream, typically from the general atmosphere or from a specially conditioned atmosphere such as one that includes exhaust gases from industrial processes.

### BACKGROUND OF THE INVENTION

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21^{st} century. Hence, DAC represents one of a range of technologies that can be employed to reduce the environmental impact of greenhouse gases like carbon dioxide and help the transition to a low carbon global economy.

Typical DAC systems take large quantities of air (or other conditioned gaseous atmosphere) which is pumped as a feedstream through a unit that contains a sorbent substance that removes the carbon dioxide from the feedstream. Over time the sorbent becomes loaded with captured carbon dioxide. Next, the captured carbon dioxide in the sorbent is extracted from the sorbent in the regeneration step. Regeneration may involve thermal or chemical processes depending upon the type of sorbent material that is selected for use in the DAC. For example, amine-functionalised resins can serve as effective sorbents that are regenerated at temperatures of above 80° C., typically up to 120° C. Upon regeneration the captured carbon dioxide is released from the sorbent and can be used to manufacture sustainable fuels, chemicals, in food and beverage production or in carbon capture and sequestration (CCS) in order to create a net negative carbon process. The energy input to the DAC system can comprise of thermal energy in the form of steam, and electrical energy for both the absorption (to move the air through the DAC unit) and regeneration (to regenerate the CO2 from the sorbent) steps.

The processes typically employed in DAC systems can be capital, energy and resource intensive which is exacerbated by the relatively low concentration of carbon dioxide in the normal atmosphere. Whilst the commercial net cost per ton of carbon dioxide captured is decreasing for current DAC set ups, further realistic operating cost reductions merely through economies of scale and technology maturation are unlikely unless the DAC systems can be powered reliably for extended periods by low cost renewable energy. However, readily available renewable energy sources such as wind and solar only output power intermittently—i.e. when the wind is blowing or the sun is shining. Non-intermittent renewable energy such as from hydropower or geothermal sources is subject to significant limitations and is not available in many countries that lack the appropriate geography, infrastructure or the resources to support the construction of major dam or geothermal energy projects. Hence, it would be desirable to provide DAC systems and set ups that can mitigate for the intermittent power supply from readily available renewable energy sources such as wind, solar PV, concentrated solar power or tidal power.

US-2008/0289495-A and WO-2008/144708 A1 describe a DAC unit that may be powered by a solar energy collection system. The solar energy may be used to drive a power generator that converts solar energy to thermal energy which, in turn, may be used to generate high pressure steam that feeds a turbine to produce electrical power for the DAC system. The solar energy collection system may be supplemented by other energy supplies derived from fossil fuel combustion, waste incineration, nuclear, biomass or geothermal sources. However, this does not address the problem of supplying the DAC unit with renewable energy. Solar energy is intermittent and in order to operate the DAC unit continuously, an energy storage unit is required to supply electrical energy and thermal energy continuously to the DAC unit.

CN-108671703-A discloses an amine-based DAC system in which electrical energy derived from renewable sources is stored in an accumulator which is used to power a centrifugal blower that directs a gaseous feedstream over the sorbent material. However, this does not address the problem of supplying the DAC unit with a continuous stream of thermal energy that is required for the continuous operation of the DAC unit, in particular for the regeneration of the sorbent.

CN-108786368-A describes a greenhouse system for agriculture that utilises a DAC system for the purpose of enhancing the carbon dioxide atmosphere within the greenhouse. A solar energy absorption device that comprises a concave mirror is used to generate steam that in turn it utilised for regeneration of sorbent material in the DAC. A storage battery is applied to provide electricity for the fans. However, this does not teach any storage of thermal energy to the DAC unit in order to enable the DAC unit to operate continuously.

Breyer et. al. (Breyer, C., Fasihi, M. & Aghahosseini, A. Carbon dioxide direct air capture for effective climate change mitigation based on renewable electricity: a new type of energy system sector coupling. Mitig Adapt Strateg Glob Change 25, 43-65 (2020). https://doi.org/10.1007/s11027-019-9847-y) describe a system where the DAC units require electricity and heat at about 100° C. for CO2 capture and regeneration. The heat is provided by electrical compression heat pumps. The heat from the heat pumps can be stored in a thermal energy storage before consumption. However, electrical compression heat pumps are restricted in the temperature of the outlet stream of 100° C. which is not a stream of low pressure or high pressure steam. As a result, the thermal energy storage is restricted to storage of low grade heat of temperatures less than or equal to 100° C. and this can only supply heat of 100° C. or lesser to the DAC unit. They cannot be used to supply steam to the DAC unit that is greater than 100° C.

There is a need to provide improved DAC systems and processes that can operate continuously using a variety of renewable energy sources. These and other objectives will become apparent from the disclosure provided herein.

### SUMMARY OF THE INVENTION

The present inventors provide DAC systems and processes for operating such systems that can operate continuously under power from a wide range of intermittent renewable energy sources.

Accordingly, the invention provides in a first aspect, a system for continuous capture of carbon dioxide from a gaseous feedstream, the system comprising: an energy storage unit for receiving, storing and continuously discharging energy provided by a renewable source of energy; and a direct air capture (DAC) unit.

In a specific embodiment, the system further comprises a steam generator, wherein the steam generator is configured to provide a supply of steam to the DAC unit and wherein the steam generator receives energy from the energy storage unit. Suitably the supply of steam may be low pressure steam and/or high pressure steam. Optionally, the steam generator is comprised within the energy storage unit.

In a further embodiment the energy provided by the renewable source of energy is suitably in the form of thermal energy. In embodiments of the invention the thermal energy is provided to the energy storage unit via a heat transfer fluid. Suitably, the energy storage unit comprises a thermal storage medium.

In yet a further embodiment, the system further comprises an electrical generator which is configured to receive a supply of high pressure steam from the steam generator.

In a further embodiment, the energy provided by the renewable source of energy is in the form of electrical energy. Accordingly, in a specific embodiment the energy storage unit further comprises an electrical storage unit. Optionally, the electrical storage unit is in electrical connection with the steam generator and/or the DAC unit.

A second aspect of the invention provides a process for continuous capture of carbon dioxide from a gaseous feedstream, wherein the process comprises providing a source of renewable energy to a system as set out herein. Optionally, the source of renewable energy is selected from one or more of the group consisting of: solar thermal; solar photovoltaic; wind; geothermal; wave; and tidal. In a particular embodiment the gaseous feedstream comprises atmospheric air and/or a carbon dioxide containing exhaust gas.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any described embodiment can be combined with other embodiments in any way and/or combination, unless such features are incompatible.

### BRIEF DESCRIPTION OF THE DRAWINGS

FIG. 1 illustrates a schematic of a continuously operating system according to an embodiment of the invention;

FIG. 2 illustrates a schematic of a continuously operating system according to another embodiment of the invention.

FIG. 3 illustrates a schematic of a continuously operating system according to a further embodiment of the invention.

FIG. 4 illustrates a schematic of a continuously operating system according to yet a further embodiment of the invention.

### DETAILED DESCRIPTION OF THE INVENTION

In general terms the present invention provides system comprising a DAC unit for capturing carbon dioxide from a gaseous feedstream with a sorbent material, and for regenerating said sorbent using energy from an intermittent renewable source of energy. The system of the invention further comprises an energy storage unit for receiving, storing, and discharging the energy required thereby enabling the DAC unit to operate continuously—e.g. throughout the day/night cycle and at all times of the year. Hence, the term “continuously” is intended to mean substantially without interruption. However, it will be appreciated that interruptions for routine maintenance or repair may need to occur, nevertheless, the systems and processes of the invention are intended to facilitate substantially continuous operation of a DAC system irrespective of the nature of the renewable energy/power source it is reliant upon.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

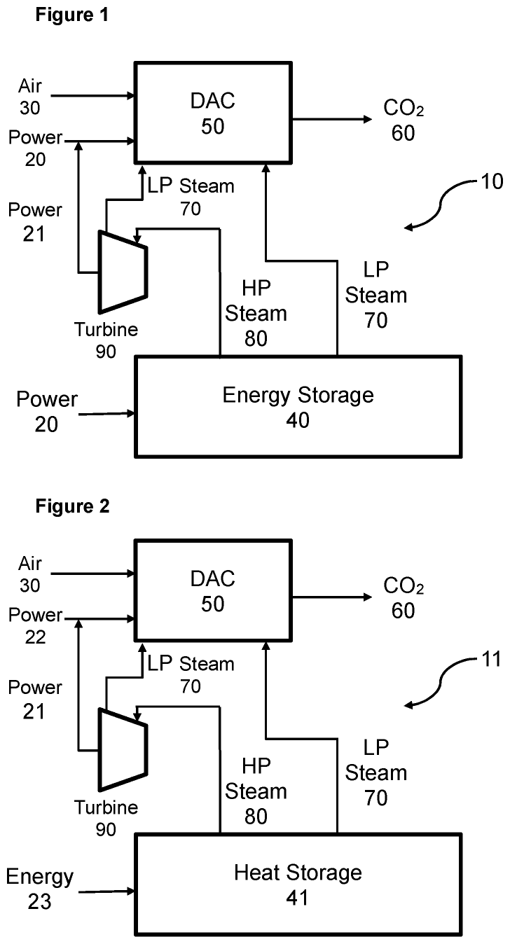

FIG. 1 shows a DAC system and process 10 according to a first embodiment of the present invention. A renewable energy source (not shown) supplies electrical power 20 to the system 10. A portion of the power supply 20 is directed to an energy storage unit 40 that comprises a thermal storage medium. Energy storage unit 40 may comprise a heat storage medium such as molten salts and/or a heat exchanger. The energy storage unit 40 may use either direct or indirect heat exchange methods. For example, if the renewable energy source comprises a solar photovoltaic, wind, geothermal or tidal apparatus, the power supply 20 is in the form of electrical energy. This electrical energy is further converted to thermal energy by means such as direct or indirect heat exchange methods. The thermal energy is further stored in a suitable medium comprising a heat transfer fluid (HTF) such as a conducting oil (mineral oil or synthetic oil), or water in conjunction with liquid molten salt or a powdered packed bed salt. Liquid-phase storage materials are typically used in so called “Active Thermal Energy Storage” systems, where storage materials circulate through heat exchangers and collectors.

In a specific embodiment of the invention the energy storage unit 40 may comprise an electrode layer that comprises a powder bed of a semiconductor material having an electrical resistivity of in the range of 500-50,000 Ωm. A plurality of electrodes are embedded in the powder bed and arranged to heat the powder bed by providing a voltage therebetween. The semiconductor material may, for example, comprise silicon carbide (SiC), optionally doped with a suitable amount of nitrogen, phosphorus, beryllium, boron, aluminium, or gallium to obtain the desired electrical resistivity. Doped silicon carbide has excellent electrical and thermal properties (in terms of conductance and storage capacity) for use in the electrode layer of the energy storage unit 40. Such doped silicon carbide may, for example, have an electrical resistivity of about 1,000 Ωm for use with an intermediate transmission grid supply voltage. Because of impurities in the bulk production of silicon carbide, undoped silicon carbide may be suitable for use as the main ingredient of the powder bed too. Undoped silicon carbide with a resistivity of up to 50,000 Ωm may, for example, be used with a high transmission grid supply voltage.

The resistivity of the powder bed does not only depend on the material of the powder bed particles used, but also on, e.g., particle size, particle shape, and the spacing between the particles. The electrical resistivity of the powder bed is preferably selected in such a way that the energy storage unit 40 can be connected directly to an electric energy supply, such as a wind farm, solar farm, or tidal barrage without requiring the use of any transformers for first converting the high voltage of the electrical power supply to a much lower voltage that can be used for heating the electrically conductive medium between the electrodes. Such a direct connection to the intermittent electrical power source allows the selected semiconductor material to simultaneously fulfil the functions of energy conversion and energy storage resulting in a significant cost reduction.

The energy storage unit 40 comprises a heat exchange system that is able to heat a supply of water by way of a boiler and generate output of high pressure (HP) steam and also low pressure (LP) steam. In the present systems, high pressure steam is typically considered to be steam at a pressure in excess of 500 kPa (approximately 72.5 psi) whereas low pressure steam is less than around 500 kPa. A high pressure steam line 80 directs the steam to a steam turbine 90 for generation of electrical power 21 that can be used in the operation of the system 10, such as in the operation of impellers such as fans that control the intake of gaseous atmosphere such as air 30 into the DAC unit 50. Low pressure steam that may be vented from the turbine 90 may be directed to the DAC unit as described further below, via a low pressure steam line 70. Electrical power 21 provided by way of the energy storage unit 40 may, therefore, supplement the intermittent power supply 20 provided by the renewable energy source.

One or more low pressure steam lines 70 provide a conduit for fluid communication between the energy storage unit 40 and the DAC unit 50 (optionally via the turbine 90). Low pressure steam is used in the regeneration of the sorbent materials within the DAC unit 50. Upon regeneration of sorbent materials within the DAC unit 50, carbon dioxide is released and conveyed out of the DAC unit 50 via a carbon dioxide conduit 60 where it may be utilised in a range of industrial/agricultural processes or stored or sequestered as necessary. Residual steam or water may be vented or recycled to the heat storage unit 40.

FIG. 2 shows a DAC system and process 11 according to a second embodiment of the present invention. A renewable energy source (not shown) supplies thermal energy 23 to the system 11. The energy stream 23 is directed to a heat storage unit 41 that comprises a thermal storage medium. Heat storage unit 41 may comprise a heat storage medium such as molten salts and/or a heat exchanger. The heat storage unit 41 may use either direct or indirect heat exchange methods. For example, if the renewable energy source comprises a solar collecting apparatus, such as a parabolic trough or linear Fresnel mirror system, the energy 23 may be in the form of a heat transfer fluid (HTF) such as a conducting oil (mineral oil or synthetic oil), or water in conjunction with liquid molten salt or a powdered packed bed salt as a heat thermal storage material. Liquid-phase storage materials are typically used in so called “Active Thermal Energy Storage” systems, where storage materials circulate through heat exchangers and collectors. According to such arrangements a heat exchanger set up may be used to transfer thermal energy from the HTF to molten or a packed bed salt to store the thermal energy.

The heat storage unit 41 comprises a heat exchange system that is able to heat a supply of water by way of a boiler and generate output of high pressure (HP) steam and also low pressure (LP) steam. In the present systems, high pressure steam is typically considered to be steam at a pressure in excess of 500 kPa (approximately 72.5 psi) whereas low pressure steam is less than around 500 kPa. A high pressure steam line 80 directs the steam to a steam turbine 90 for generation of electrical power 21 that can be used in the operation of the system 11, such as in the operation of impellers such as fans that control the intake of gaseous atmosphere such as air 30 into the DAC unit 50. Low pressure steam that may be vented from the turbine 90 may be directed to the DAC unit as described further below, via a low pressure steam line 70. Electrical power 21 provided by way of the heat storage unit 41 may, therefore, supplement or replace an optional external electrical power supply 22, for example provided by a renewable power source.

One or more low pressure steam lines 70 provide a conduit for fluid communication between the heat storage unit 41 and the DAC unit 50 (optionally via the turbine 90). Low pressure steam is used in the regeneration of the sorbent materials within the DAC unit 50. Upon regeneration of sorbent materials within the DAC unit 50, carbon dioxide is released and conveyed out of the DAC unit 50 via a carbon dioxide conduit 60 where it may be utilised in a range of industrial/agricultural processes or stored or sequestered as necessary. Residual steam or water may be vented or recycled to the heat storage unit 41.

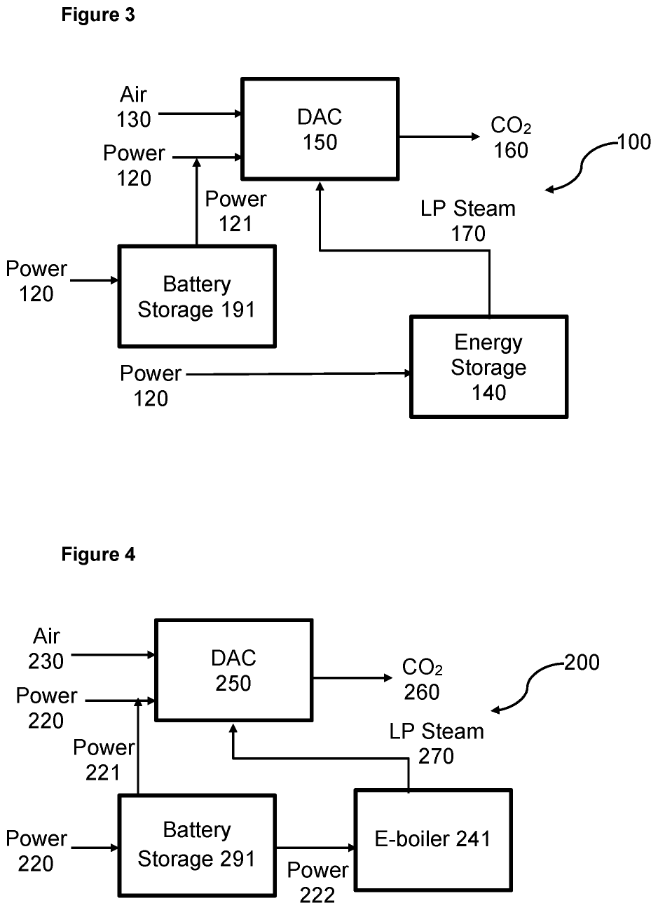

FIG. 3 shows a third embodiment of a system and process of the present invention 100 in which a renewable energy source (not shown) supplies electrical power 120 to the system 100. A portion of the power supply 120 may be used to supply the DAC unit 150 which removes carbon dioxide from a feedstream of a gaseous atmosphere such as air 130. However, it will be appreciated that this direct supply may be subject to interruption due to the intermittent nature of some renewable energy sources. A portion of the power supply 120 may be directed to an electrical storage unit 191 such as a battery or electrical energy cell. The electrical storage unit 191 can provide supply electrical power 121 that can be used in the operation of the system 100 as a whole or simply of the DAC unit 150. Electrical power 121 provided by way of the electrical storage unit 191 may, therefore, supplement or mitigate for an intermittent power supply 120 provided by the renewable energy source.

In parallel, a portion of the power 120 from the renewable energy source is also directed to a heat storage unit 140 that can comprise a heat exchange system that is able to store thermal energy. When needed the stored thermal energy can be used to heat a supply of water by way of a boiler and generate an output of low pressure (LP) steam.

A low pressure steam line 170 provides a conduit for fluid communication between the heat storage unit 140 and the DAC unit 150. Low pressure steam can then be used in the regeneration of the sorbent materials within the DAC unit 150. Upon regeneration of sorbent materials within the DAC unit 150, carbon dioxide is released and conveyed out of the DAC unit 150 via a carbon dioxide conduit 160. Residual steam or water from the DAC unit 150 may be vented or recycled to the heat storage unit 140.

FIG. 4 shows a fourth embodiment of a system and process of the present invention 200 in which a renewable energy source (not shown) supplies electrical power 220 to the system 200. A portion of the power supply 220 may also be used to supply the DAC unit 250 which removes carbon dioxide from a feedstream of a gaseous atmosphere such as air 230. However, as described in the previous embodiments, this power supply 220 may be subject to interruption. A portion of the power supply 220 is directed to an electrical storage unit 291. The electrical storage unit 291 can supply electrical power 221 that can be used in the operation of the system 200 as a whole or simply of the DAC unit 250 when the power supply 220 from renewable energy source is interrupted.

Electrical power 222 may also be supplied by the electrical storage unit to an electrically powered water boiler (i.e. an E-boiler) 241, such as an immersion heater, to generate low pressure steam. A low pressure steam line 270 provides a conduit for fluid communication between the boiler 241 and the DAC unit 250. This allows for the low pressure steam to be used in the regeneration of the sorbent materials within the DAC unit 250. Upon regeneration of sorbent materials within the DAC unit 250, carbon dioxide is released and conveyed out of the DAC unit 250 via a carbon dioxide conduit 260. As described previously, residual water or steam may be vented or recycled as needed within the system 200.

It is a particular advantage of the systems of the invention as described herein, that they provide power compensation to supplement periodic loss of capacity in conventional DAC systems. Hence, the embodiments of the invention described herein allow not only for the continuous operation of a DAC unit in terms of uninterrupted electrical power supply but also uninterrupted sorbent regeneration. This removes the requirements to ramp up or ramp down the systems in response to power availability and demand.

In a specific embodiment of the invention the systems described herein may comprise one or more control units that monitor power supply and provide a balancing function between drawing on power (21, 121, 221) provided by the energy/heat storage unit and the direct power supply (20, 22, 120, 220) to the DAC unit that may be provided by an intermittent energy supply. The control unit may comprise one or more computers (e.g. CPUs) that are in direct electrical communication with the various components of the systems, or which monitor the systems via remote telemetry (e.g. via a cloud based remote monitoring system).

The invention is further exemplified in the following non-limiting example.

### EXAMPLE

The following example refers to the process as explained in the different embodiments of the present disclosure. Table 1 illustrates the specifications for an exemplary modelled system at a particular location.

TABLE 1

| | | |
|---|---|---|
| Rate of CO2 captured | 100 | tons/hr |
| Thermal energy demand | 300 | MW |
| Electrical energy demand | 40 | MW |
| Desired run time | 24 | hours/day |
| of DAC unit | | |

Renewable energy is required to power the DAC unit. An assumption has been made that the chosen location has a constant solar irradiation profile of 8 hrs every day throughout the year. A solar photovoltaic array is used to provide renewable energy in the form of electrical power to the DAC unit. A storage unit is required to supply thermal energy and electrical energy to the DAC unit for the balance of 16 hours every day in order to keep the DAC unit operating continuously.

Since the DAC unit requires both thermal and electrical energy, part of the renewable electrical energy is converted to thermal energy. This thermal energy is stored in the form of a heat storage system as described in the embodiments of the present disclosure. The rest of the electrical energy is stored as is in the electrical energy storage unit. Table 2 illustrates the assumed efficiencies of the different storage units including conversion of electrical energy to thermal energy based upon conventional operational data.

TABLE 2

| | |
|---|---|
| Efficiency of the heat | 100% |
| storage unit | |
| Efficiency of the electrical | 90% |
| storage unit | |
| Efficiency of conversion | 99% |
| of electrical energy to | |
| thermal energy | |

Table 3 illustrates the estimated sizing requirements of the Solar photovoltaic array required for the DAC unit to operate continuously along with the sizing of the electrical and thermal storage units, based upon the assumptions made in Tables 1 and 2.

TABLE 3

| | | |
|---|---|---|
| Total storage time required | 16 | hours/day |
| Electrical energy required | 40 | MW |
| for the DAC unit | | |
| Electrical energy storage | 40 | MW |
| unit discharge capacity | | |
| Electrical energy storage | 640 | MWh |
| unit size | | |
| Electrical energy required | 89 | MW |
| for storage unit | | |
| Total electrical energy | 129 | MW |
| required to satisfy DAC | | |
| electrical energy demand | | |
| Thermal energy required | 300 | MW |
| for DAC unit | | |
| Thermal energy storage | 300 | MW |
| unit discharge capacity | | |
| Thermal energy storage | 4800 | MWh |
| unit size | | |
| Total thermal energy | 900 | MW |
| required to satisfy DAC | | |
| thermal energy demand | | |
| Total electrical energy | 909 | MW |
| required to satisfy DAC | | |
| thermal energy demand | | |
| Total size of solar | 1038 | MW |
| photovoltaic array | | |

Thus, in order for the DAC unit, with the energy requirements as specified in Table 1, located in a particular location, to be operated continuously only with renewable power, a solar photovoltaic array of 1038 MW is required along with electrical and thermal energy storage units. The size of the required thermal energy storage unit is estimated to be 909 MW, and the size of the required electrical energy unit is 129 MW.

1. A system for continuous capture of carbon dioxide from a gaseous feedstream, the system comprising:
an energy storage unit for receiving, storing and discharging energy provided by a renewable source of energy continuously; and
a direct air capture (DAC) unit:
wherein the energy provided by the renewable source of energy is in the form of electrical energy; wherein the electrical energy is converted to thermal energy and is stored in the energy storage unit; and
a steam generator, wherein the steam generator is configured to provide a supply of steam to the DAC unit, and wherein the steam generator receives energy from the energy storage unit.

2. The system as claimed in claim 1, wherein the thermal energy is provided to the energy storage unit via a heat transfer fluid.

3. The system as claimed in claim 2, wherein the energy storage unit comprises a thermal storage medium.

4. The system as claimed in None of, wherein the steam generator is comprised within the energy storage unit.

5. The system of claim 4, wherein the steam generator is further configured to provide a supply of steam, suitably low pressure and/or high pressure steam.

6. The system of claim 5, wherein the system further comprises an electrical generator which is configured to receive a supply of high pressure steam from the steam generator.

7. The system as claimed in claim 1, wherein the energy storage unit further comprises an electrical storage unit.

8. The system as claimed in claim 7, wherein the electrical storage unit is in electrical connection with the steam generator and/or the DAC unit.

9. A process for continuous direct air capture (DAC) of carbon dioxide from a gaseous feedstream, wherein the process comprises providing a source of renewable energy to a system as set out in claim 1.

10. The process of claim 9, wherein the source of renewable energy is selected from one or more of the group consisting of: solar thermal; solar photovoltaic; wind; geothermal; wave; and tidal.

11. The process of claim 9, wherein the gaseous feedstream comprises atmospheric air and/or a carbon dioxide containing exhaust gas.
